(19) United States
(12) Patent Application Publication
(10) Pub. No.: US 2003/0204528 A1
(43) Pub. Date: Oct. 30, 2003

(54) Semiconductor wafer manufacturing execution system with special engineer requirement database

(76) Inventors: Yeaun-Jyh Su, Hsinchu (TW); Chen-Chung Yu, Hsinchu (TW); Chih-Huang Lin, Hsinchu (TW); Chu-Shan Yu, Hsinchu (TW)

Correspondence Address: STOUT, UXA, BUYAN & MULLINS LLP, 4 VENTURE, SUITE 300, IRVINE, CA, 92618, US

(21) Appl. No.: 10/136,754

(22) Filed: Apr. 30, 2002

(51) Int. Cl. G06F 7/00

(52) U.S. Cl. 707/104.1

(57) ABSTRACT

A manufacturing execution system (MES) is disclosed including a first database and a second database. The first database (e.g., a basic database) stores a first set of records, wherein each of the first set of records includes information regarding a routine operation to be performed on at least one semiconductor wafer when the at least one semiconductor wafer is positioned within a process tool. The second database (e.g., a special engineer requirement, or SER, database) stores a second set of records, wherein each of the second set of records includes information regarding a special operation to be performed on the at least one semiconductor wafer when positioned within the process tool. A method is also described, which may be embodied within the MES. The method includes receiving operation data from the process tool, wherein the operation data includes information regarding a selected operation (e.g., a user-selected recipe) to be performed within the process tool. The operation data is compared with each of the first set of records and the second set of records. An alarm signal is provided to the process tool if the operation data does not match any one of the first and second pluralities of records.

### CROSS-REFERENCE TO RELATED APPLICATIONS

This patent application is related to a co-pending patent application entitled “Semiconductor Wafer Manufacturing Execution System With Recipe Distribution Management Database” filed on Apr. 30, 2002, which is commonly assigned and the contents of which are expressly incorporated herein by reference.

### BACKGROUND OF THE INVENTION

1. Field of the Invention

The present invention relates generally to semiconductor fabrication systems, and, more particularly, to semiconductor wafer fabrication systems including manufacturing execution systems.

2. Description of Related Art

Integrated circuits are typically formed by processing several semiconductor wafers as a group or “lot” through a series of wafer fabrication process tools (i.e., “process tools”). Each process tool typically performs a single wafer fabrication operation on the semiconductor wafers. The integrated circuits formed in this manner are substantially identical to one another. Following wafer fabrication, the integrated circuits are typically subjected to functional testing, and then separated. An individual integrated circuit is called a “chip” or a “die.” Fully functional die are typically packaged and sold as individual units.

Driven by fierce competition, semiconductor fabrication facilities are economically compelled to ensure efficient scheduling and utilization of process tools. To increase equipment productivity, many modern semiconductor wafer fabrication systems include a centralized manufacturing execution system (MES). Functions performed by a typical MES may include: work in process (WIP) tracking, resource allocation and status, operations scheduling, quality data collection, and process control. A MES may function as a central depository for data collection and distribution. For instance, a MES can, in real-time, dynamically collect, combine and express the data of raw materials, finished products, semi-finished products, machines, time, costs, etc., and can trace and control each manufacturing process.

A typical MES can include a single database for storing information used to automatically monitor and control process tools. For example, in a semiconductor wafer fabrication system including a MES, the single database of the MES may be a “basic” database including “basic” records, wherein each basic record includes information to be used by a process tool to automatically execute a process.

A problem can arise in the above described semiconductor wafer fabrication system when a process tool must be operated to perform a non-standard or special procedure. Such non-standard or special procedures may be required, for example, to compensate for a manufacturing deviation in a preceding process, such as a proceeding experimental process.

Each time a process tool must be operated to perform a non-standard or special procedure, a user must typically manually input information to be used by the process tool to carry out the non-standard or special procedure. Such manual inputting of information can be both tedious and prone to error. While it may be possible to enter information regarding at least some non-standard or special procedures in the single database along with the information regarding standard or “basic” procedures, this action can make it difficult to maintain the database. As an example, a lot “1” can be an experimental lot that assigns an experimental recipe on tool A, wherein the experimental recipe is a non-standard recipe for tool A. Consequently, the data to assign the lot “1” used for the experiment on tool A needs to be input, just for lot “1” in the example. After the lot “1” is processed, the data on the MES must be deleted, but the MES includes a large quantity of data that is changed frequently thereby increasing a risk of introduction of erroneous data.

Accordingly, a need exists in the prior art for an independent database that can record the special lot data, wherein an error in this database will not impact the MES data so that the production lots are not impacted. A need further exists in the prior art for storage of information relating to non-standard or special procedures which are to be performed by a process tool, separate from standard or basic procedures of the process tool.

### SUMMARY OF THE INVENTION

A manufacturing execution system (MES) is disclosed including a first database and a second database. The first database (e.g., a basic database) stores a first set of records, wherein each of the first set of records includes information regarding a routine operation to be performed on at least one semiconductor wafer when the at least one semiconductor wafer is positioned within a process tool. The second database (e.g., a special engineer requirement, or SER, database) stores a second set of records, wherein each of the second set of records includes information regarding a special operation to be performed on the at least one semiconductor wafer when positioned within the process tool.

A method is also described, which may be embodied within the MES. The method includes receiving operation data from the process tool, wherein the operation data includes information regarding a selected operation (e.g., a user-selected recipe) to be performed within the process tool. The operation data is compared with each of the first set of records and the second set of records. An alarm signal is provided to the process tool if the operation data does not match any one of the first and second sets of records.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

FIG. 1 is a diagram of one embodiment of a semiconductor wafer fabrication system including a wafer fabrication process tool (i.e., process tool) operably coupled to a MES, wherein the MES includes a basic database and a “special engineer requirement” (SER) database;

FIG. 2 is a diagram of one embodiment of the basic database of FIG. 1;

FIG. 3 is a diagram of one embodiment of the SER database of FIG. 1; and

FIG. 4 is a flow chart of a method for ensuring that a selected procedure to be performed within the process tool of FIG. 1 is present in either the basic database or the SER database.

### DETAILED DESCRIPTION OF THE PRESENTLY PREFERRED EMBODIMENTS

Reference will now be made in detail to the presently preferred embodiments of the invention, examples of which are illustrated in the accompanying drawings. Wherever possible, the same or similar reference numbers are used in the drawings and the description to refer to the same or like parts. It should be noted that the drawings are in simplified form and are not to precise scale.

Although the disclosure herein refers to certain illustrated embodiments, it is to be understood that these embodiments are presented by way of example and not by way of limitation. The intent of the following detailed description, although discussing exemplary embodiments, is to be construed to cover all modifications, alternatives, and equivalents of the embodiments as may fall within the spirit and scope of the invention as defined by the appended claims. It is to be understood and appreciated that the process steps and structures described herein do not cover a complete process flow for the semiconductor manufacturing execution system (MES) disclosed herein. The present invention may be practiced in conjunction with various semiconductor manufacturing techniques that are conventionally used in the art, and only so much of the commonly practiced process steps are included herein as are necessary to provide an understanding of the present invention.

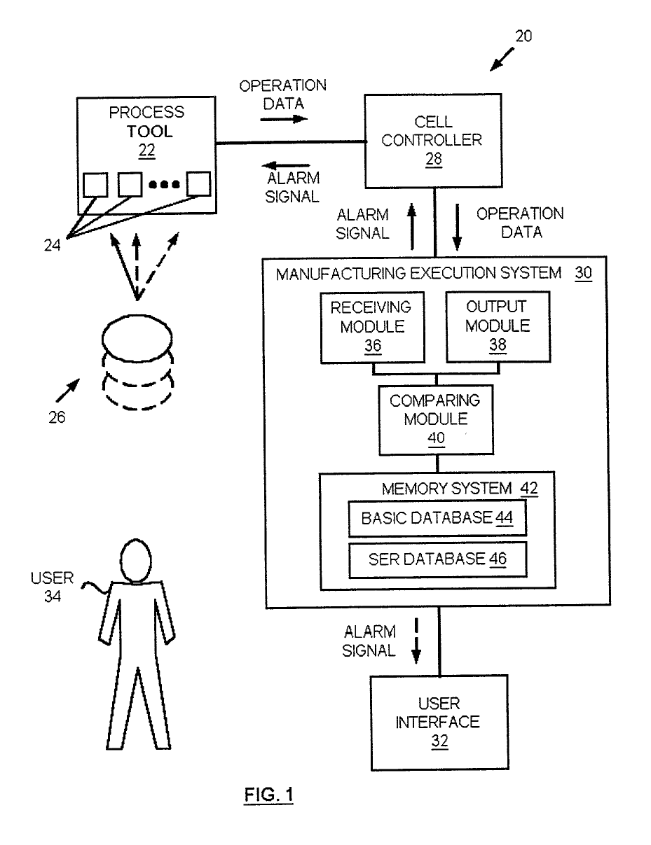

Referring to FIG. 1, one embodiment of a semiconductor wafer fabrication system 20 is shown including a wafer fabrication process tool (i.e., process tool) 22 having multiple processing chambers 24. Each of the processing chambers 24 is configured to receive one or more semiconductor wafers 26 of a wafer group or “lot.” It is noted that, in general, the process tool 22 may include one or more processing chambers 24.

The process tool 22 is configured to perform a wafer fabrication operation on the semiconductor wafers 26, when positioned within one of the chambers 24, according to a predefined procedure (i.e., a predetermined set of steps or “recipe”). During the wafer fabrication operation, at least one surface of each of the one or more semiconductor wafers 26 is altered in some way.

For example, the processing tool 22 may be configured to perform a layering operation, a patterning operation, a doping operation, or a heat treatment upon the semiconductor wafers 26. A layering operation typically adds a layer of a desired material to an exposed surface of the semiconductor wafers. A patterning operation typically contributes to the removal of selected portions of one or more layers formed by layering. A doping operation typically places dopant atoms upon and within exposed surfaces of the semiconductor wafers, thereby producing p-n junctions required for semiconductor operation.

In the embodiment of FIG. 1, the semiconductor wafer fabrication system 20 also includes a cell controller 28, a MES 30, and a user interface 32. As indicated in FIG. 1, the cell controller 28 is operably coupled to, and in communication with, the process tool 22 and the MES 30.

In general, the MES 30 is configured to control the operations of the cell controller 28, and the cell controller 28 is configured to control the operations of the process tool 22. The user interface 32 is configured to accept input from a user 34, and to provide the input to the MES 30. The cell controller 28, the MES 30, and the user interface 32 may be, for example, embodied within separate computer systems. The cell controller 28 preferably establishes signal communications with the process tool 22 using message transfer protocols described by Semiconductor Equipment and Materials International (SEMI) (San Jose, Calif.) E5, and communicates with the process tool 22 using the SEMI equipment communication standard II (SECS II). The SEMI equipment communication standard (SECS) specifies a group of messages, and the respective syntax and semantics for those messages, relating to semiconductor manufacturing equipment control. Those skilled in the art will recognize that other communications standards exist, and a semiconductor MES using another communications standard is intended to come within the scope of the present invention.

In the embodiment of FIG. 1, the MES 30 includes a receiving module 36, an output module 38, a comparing module 40, and a memory system 42. The receiving module 36 is operably coupled to the cell controller 28, and to the comparing module 40. The receiving module 36 inputs data through the interface, and the output module 38 outputs data through the interface. In general, the receiving module 36 is configured to receive signals from the cell controller 28, wherein the received signals convey for example operation data from the process tool 22. The output module 38 is operably coupled to the cell controller 28, the comparing module 40, and to the user interface 32. In general, the output module 38 is configured to provide signals to the cell controller 28, and optionally to the user interface 32. For example, the output module 38 can output an alarm signal to the process tool 22 via the cell controller 28 and can output an alarm signal to the user interface 32. The comparing module 40 is operably coupled to the memory system 42.

The receiving module 36, the output module 38, and/or the comparing module 40 may be embodied within software, hardware (e.g., application-specific integrated circuit), or a combination of software and hardware. For instance, the modules 36, 38, 40, and 42 may be implemented in a computer apparatus. The computer apparatus may be a conventional computer device, which may include a storage device, an interface, an input device, and a central processing unit (CPU). The storage device may be a computer readable data storage device such as a hard disk drive (HDD), a compact disk read-only memory (CD-ROM), dynamic random access memory (DRAM) or EEPROM. The interface establishes signal communications between the cell controller 28 and the user interface 32. The preferred interface is a local area network (LAN); however, those skilled in the art will recognize that the interface may use other communications methods, and those other methods are intended to fall within the scope of the present invention.

The memory system 42 includes a basic database 44 and a special engineer requirement (SER) database 46. In general, the basic database 44 includes information regarding established standard, basic, or routine procedures which may be performed on semiconductor wafers positioned within the process tool 22. The SER database 46 includes information regarding established non-standard or special procedures which may be performed on semiconductor wafers positioned within the process tool 22. The memory system 42 may be implemented in the storage device of a computer apparatus and/or may include, for example, one or more memory devices (e.g., dynamic random access memory or DRAM devices), and/or one or more data storage devices (e.g., hard disk drives, compact disk read-only memories or CD-ROMs, etc.).

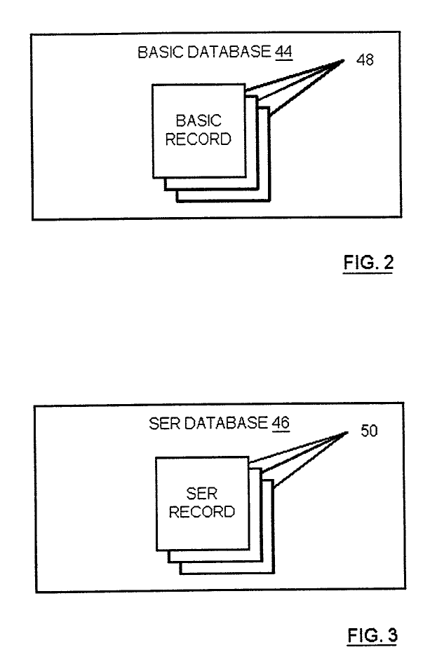

FIG. 2 is a diagram of one embodiment of the basic database 44 of FIG. 1. In the embodiment of FIG. 2, the basic database 44 includes multiple basic records 48. In general, the basic database 44 includes at least one basic record 48. In one embodiment, each of the basic records 48 includes a lot ID, a recipe ID, and a chamber ID, which for example can be used for auto-execution in the process tool 22. The lot ID identifies a lot of semiconductor wafers (e.g., the lot including the semiconductor wafers 26). The recipe ID identifies a standard, basic, or routine set of steps (i.e., recipe) the process tool 22 is to perform on the semiconductor wafers 26. The chamber ID identifies one of the chambers 24 in which the semiconductor wafers 26 are to be positioned during the standard, basic, or routine processing.

FIG. 3 is a diagram of one embodiment of the SER database 46 of FIG. 1. In the embodiment of FIG. 3, the SER database 46 includes multiple SER records 50. In general, the SER database 46 includes at least one SER record 50. In one embodiment, each of the SER records 50 includes a lot ID, a recipe ID, and a chamber ID, which for example can be used for manual-execution in the process tool 22. The lot ID identifies a lot of semiconductor wafers (e.g., the lot including the semiconductor wafers 26). The recipe ID identifies a SER set of steps (i.e., recipe) the process tool 22 is to perform on the semiconductor wafers 26. The chamber ID identifies one of the chambers 24 in which the semiconductor wafers 26 are to be positioned during the SER processing.

Referring back to FIG. 1, one key aspect of the operation of the semiconductor wafer fabrication system 20 is to ensure that any procedure to be performed on semiconductor wafers within the process tool 22 (e.g., while the semiconductor wafer fabrication system 20 is in a manual mode) is present (i.e., specified by a record) within either the basic database 44 or the SER database 46.

The semiconductor wafer fabrication system 20 includes both automatic and manual operating modes, and the process tool 22 may perform processing operations on the semiconductor wafers 26 in both the automatic and manual modes. For example, the user 34 may configure the semiconductor wafer fabrication system 20 for manual operation, place the semiconductor wafers 26 into one of the chambers 24 of the process tool 22, and select a recipe (e.g., via the user interface 32). In one embodiment, the recipe includes a recipe ID and a chamber ID. The recipe ID identifies a set of steps (i.e., recipe) the process tool 22 is to perform on the semiconductor wafers 26, and the chamber ID identifies the one of the chambers 24 in which the semiconductor wafers 26 are positioned.

After the user 34 selects the recipe, and prior to the process tool 22 performing any step of the recipe on the semiconductor wafers 26, the process tool 22 provides operation data to the cell controller 28, and the cell controller 28 provides the operation data to the receiving module 36. The operation data includes a lot ID of the semiconductor wafers 26, and the recipe ID and chamber ID corresponding to the recipe selected by the user 34.

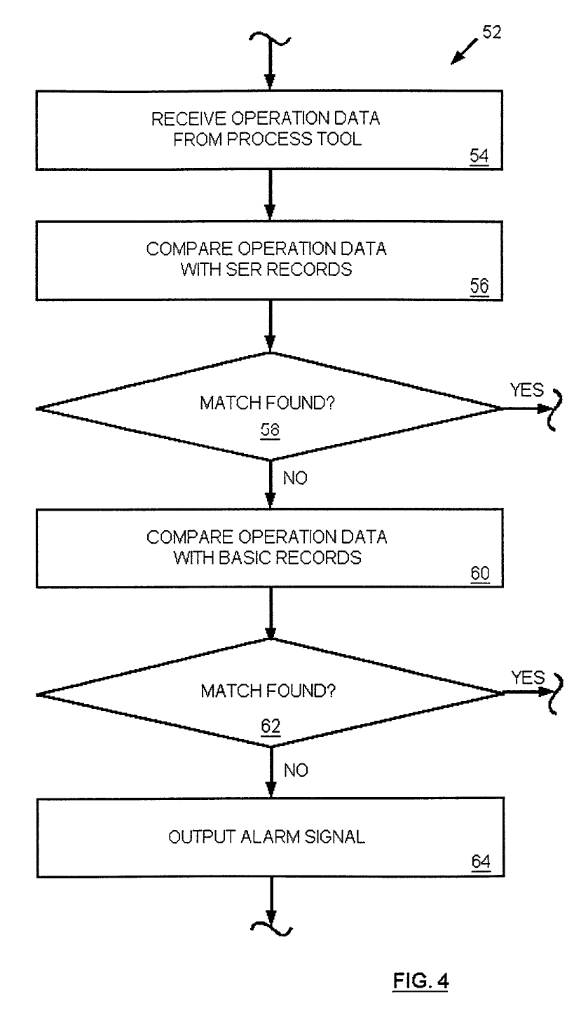

FIG. 4 is a flow chart of a method 52 for ensuring that a selected procedure to be performed on semiconductor wafers positioned within the process tool 22 (FIG. 1) is present (i.e., specified by a record) within either the basic database 44 (FIGS. 1 and 2) or the SER database 46 (FIGS. 1 and 3). The method 52 of FIG. 4 may be embodied within the MES 30 (FIG. 1), and may be carried out by the MES 30 when the semiconductor wafer fabrication system 20 is in the manual mode.

During an operation 54 of the method 52, operation data is received from the process tool 22 (FIG. 1). As described above, the receiving module 36 (FIG. 1) of the MES 30 (FIG. 1) receives the operation data. As an example, a user 34 selects a manual mode of the MES 30, and selects an online-local mode of the SECS II first. The user 34 inputs a lot (with the lot ID) into the process tool 22 and tracks in the lot ID on the MES 30. Then, the user selects a recipe in the MES 30. The recipe includes the recipe ID and chamber ID. After the recipe is selected, the process tool 22 sends the lot ID, recipe ID and chamber ID as operation data to the cell controller 28 by SECSII, and then the cell controller 28 sends that operation data to the MES 30 by network.

The operation data is compared with SER records 50 (FIG. 3) of the SER database 46 (FIGS. 1 and 3) during an operation 56 of the method 52. The receiving module 36 (FIG. 1) provides the operation data to the comparing module 40 (FIG. 1). The comparing module 40 accesses the SER records 50 (FIGS. 1 and 3) within the SER database 46 (FIG. 1), and compares the lot ID, recipe ID, and chamber ID of the operation data with the lot ID, recipe ID, and chamber ID, respectively, of each of the SER records 50.

During a decision operation 58 of the method 52, if one of the SER records 50 (FIG. 3) has a lot ID, recipe ID, and chamber ID which are the same as (i.e., match) the lot ID, recipe ID, and chamber ID, respectively, of the operation data, the processing of the semiconductor wafers 26 (FIG. 1) within the process tool 22 (FIG. 1) is permitted. The comparing module 40 (FIG. 1) may, for example, provide an enable signal to the output module 38 (FIG. 1). The output module 38 may provide the enable signal to the cell controller 28 (FIG. 1), and the cell controller 28 may provide the enable signal to the process tool 22 (FIG. 1). In response to the enable signal, the process tool 22 may initiate the processing of the semiconductor wafers 26 within the process tool 22.

On the other hand, if none of the SER records 50 (FIG. 3) has a lot ID, recipe ID, and chamber ID which matches the lot ID, recipe ID, and chamber ID, respectively, of the operation data, an operation 60 of the method 52 is performed. During the operation 60, the comparing module 40 (FIG. 1) accesses the basic records 48 (FIGS. 1 and 2) within the basic database 44 (FIG. 1), and compares the lot ID, recipe ID, and chamber ID of the operation data with the lot ID, recipe ID, and chamber ID, respectively, of each of the basic records 48 (FIG. 2) of the basic database 44.

During a decision operation 62 of the method 52, if one of the basic records 48 (FIG. 2) has a lot ID, recipe ID, and chamber ID which are the same as (i.e., match) the lot ID, recipe ID, and chamber ID, respectively, of the operation data, the processing of the semiconductor wafers 26 (FIG. 1) within the process tool 22 (FIG. 1) is permitted. As described above, the comparing module 40 (FIG. 1) may, for example, provide the enable signal to the output module 38 (FIG. 1). The output module 38 may provide the enable signal to the cell controller 28 (FIG. 1), and the cell controller 28 may provide the enable signal to the process tool 22. In response to enable signal, the process tool 22 may initiate the processing of the semiconductor wafers 26 within the process tool 22.

On the other hand, if none of the basic records 48 (FIG. 2) has a lot ID, recipe ID, and chamber ID which matches the lot ID, recipe ID, and chamber ID, respectively, of the operation data, an operation 64 of the method 52 is performed. At this point, the processing of the semiconductor wafers 26 (FIG. 1) within the process tool 22 (FIG. 1) is not permitted, and the comparing module 40 (FIG. 1) provides an alarm signal to the output module 38 (FIG. 1). The output module 38 provides the alarm signal to the cell controller 28 (FIG. 1), and the cell controller 28 provides the alarm signal to the process tool 22. In response to the alarm signal, the process tool may halt the processing of the semiconductor wafers 26 within the process tool 22.

During the operation 64, the output module 38 may (optionally) also provide the alarm signal to the user interface 32 (FIG. 1). In response to the alarm signal, the user interface 32 may convey an alarm condition to (i.e., alert) the user 34 (FIG. 1). For example, in response to the alarm signal, the user interface 32 may light an alarm indicator, sound an audible alarm, etc.

In the embodiment of the method 52 of FIG. 4, operation data is first compared with the SER records 50 (FIG. 3) of the SER database 46 (FIGS. 1 and 3), before being compared with the basic records 48 (FIGS. 1 and 2) of the basic database 44 (FIG. 1). This is due to the fact that when a user places the MES 30 (FIG. 1) in the manual mode, the user is most likely to select a SER operation. It is noted, however, that in other embodiments of the method 52, the operation data may be compared with the basic records 48 of the basic database 44 prior to, or simultaneously with, being compared with the SER records 50 of the SER database 46.

The above-described embodiments have been provided by way of example, and the present invention is not limited to these examples. Multiple variations and modification to the disclosed embodiments will occur, to the extent not mutually exclusive, to those skilled in the art upon consideration of the foregoing description. Such variations and modifications, however, fall well within the scope of the present invention as set forth in the following claims.

1. A manufacturing execution system, comprising:
a first database storing a first plurality of records, wherein each of the first plurality of records comprises information indicative of a routine operation to be performed on at least one semiconductor wafer when the at least one semiconductor wafer is positioned within a process tool; and
a second database storing a second plurality of records, wherein each of the second plurality of records comprises information indicative of a special operation to be performed on the at least one semiconductor wafer when the at least one semiconductor wafer is positioned within the process tool.

2. The manufacturing execution system as recited in claim 1, wherein the first database comprises a basic database, and wherein the second database comprises a special engineer requirement (SER) database.

3. The manufacturing execution system as recited in claim 1, wherein each of the first plurality of records comprises a lot ID assigned to the at least one semiconductor wafer, and a recipe ID indicative of the routine operation.

4. The manufacturing execution system as recited in claim 1, wherein the process tool comprises a plurality of chambers configured to receive the at least one semiconductor wafer, and wherein each of the first plurality of records comprises a chamber ID indicative of one of the chambers into which the at least one semiconductor wafer is to be positioned within the process tool during performance of the routine operation.

5. The manufacturing execution system as recited in claim 1, wherein each of the second plurality of records comprises a lot ID assigned to the at least one semiconductor wafer, and a recipe ID indicative of the special operation.

6. The manufacturing execution system as recited in claim 1, wherein the process tool comprises a plurality of chambers configured to receive the at least one semiconductor wafer, and wherein each of the second plurality of records comprises a chamber ID indicative of one of the chambers into which the at least one semiconductor wafer is to be positioned within the process tool during performance of the special operation.

7. The manufacturing execution system as recited in claim 1, further comprising:
a receiving module configured to receive operation data from the process tool;
a comparing module configured to access the first database and the second database, and to compare the operation data with each of the first and second pluralities of records; and
an output module configured to provide an alarm signal to the process tool when the operation data does not match any one of the first and second pluralities of records.

8. The manufacturing execution system as recited in claim 7, wherein the operation data is indicative of a selected operation to be performed on the at least one semiconductor wafer.

9. A manufacturing execution system, comprising:
a receiving module configured to receive operation data from a process tool, wherein the process tool is configured to perform a selected operation on at least one semiconductor wafer positioned within the process tool;
a memory system, comprising:
a first database storing a first plurality of records, wherein each of the first plurality of records comprises information indicative of a basic operation to be performed on the at least one semiconductor wafer; and
a second database storing a second plurality of records, wherein each of the second plurality of records comprises information indicative of a special engineer requirement (SER) operation to be performed on the at least one semiconductor wafer;
a comparing module configured to access the first and second databases, and to compare the operation data with each of the first and second pluralities of records; and
an output module configured to provide an alarm signal to the process tool when the operation data does not match any one of the first and second pluralities of records.

10. The manufacturing execution system as recited in claim 9, wherein the first database is a basic database comprising basic records used for auto-execution in the process tool, and wherein the second database is a SER database comprising SER records used for manual-execution in the process tool.

11. The manufacturing execution system as recited in claim 9, wherein the operation data comprises a lot ID assigned to the at least one semiconductor wafer, a recipe ID indicative of the selected operation, and a chamber ID indicative of one of the chambers into which the at least one semiconductor wafer are currently positioned within the process tool.

12. The manufacturing execution system as recited in claim 9, wherein the receiving module receives the operation data from the process tool a cell controller; and
the output module outputs the alarm signal to the process tool through the cell controller.

13. The manufacturing execution system as recited in claim 9, wherein:
each of the first plurality of records comprises a lot ID assigned to the at least one semiconductor wafer, and a recipe ID indicative of the basic operation, and a chamber ID indicative of one of the chambers into which the at least one semiconductor wafer are to be positioned within the process tool during performance of the basic operation; and
each of the second plurality of records comprises a lot ID assigned to the at least one semiconductor wafer, and a recipe ID indicative of the SER operation, and a chamber ID indicative of one of the chambers into which the at least one semiconductor wafer are to be positioned within the process tool during performance of the SER operation.

14. A semiconductor wafer fabrication system, comprising:
a process tool configured to perform a selected operation on at least one semiconductor wafer positioned within the process tool;
a manufacturing execution system operably coupled to the process tool and comprising:
a first database storing a first plurality of records, wherein each of the first plurality of records comprises information indicative of a routine operation to be performed on the least one semiconductor wafer; and
a second database storing a second plurality of records, wherein each of the second plurality of records comprises information indicative of a special operation to be performed on the at least one semiconductor wafer.

15. The semiconductor wafer fabrication system as recited in claim 14, wherein the first database comprises a basic database, and wherein the second database comprises a SER database.

16. A semiconductor wafer fabrication system, comprising:
a process tool configured to perform a selected operation on at least one semiconductor wafer positioned within the process tool;
a manufacturing execution system, comprising:
a receiving module configured to receive operation data from the process tool, wherein the operation data is indicative of the selected operation;
a memory system, comprising:
a first database storing a first plurality of records, wherein each of the first plurality of records comprises information indicative of a basic operation to be performed on the at least one semiconductor wafer; and
a second database storing a second plurality of records, wherein each of the second plurality of records comprises information indicative of a special engineer requirement (SER) operation to be performed on the at least one semiconductor wafer;
a comparing module configured to access the first and second databases, and to compare the operation data with each of the first and second pluralities of records; and
an output module configured to provide an alarm signal to the process tool when the operation data does not match any one of the first and second pluralities of records.

17. The semiconductor wafer fabrication system as recited in claim 16, wherein the first database is a basic database, and wherein the second database is a SER database.

18. A method, comprising:
receiving operation data from a process tool, wherein the operation data is indicative of a selected operation to be performed within the process tool;
comparing the operation data with each of a first plurality of records and a second plurality of records, wherein each of the first plurality of records comprises information indicative of a special operation to be performed within the process tool, and wherein each of the second plurality of records comprises information indicative of a routine operation to be performed within the process tool; and
providing an alarm signal to the process tool if the operation data does not match any one of the first and second pluralities of records.

19. The method as recited in claim 18, further comprising providing the alarm signal to a user interface to alert a user if the operation data does not match any one of the first and second pluralities of records.

20. A method, comprising:
receiving operation data from a process tool, wherein the operation data is indicative of a selected operation to be performed within the process tool;
comparing the operation data with each of a first plurality of records, wherein each of the first plurality of records comprises information indicative of a special operation to be performed within the process tool;
if the operation data does not match any one of the first plurality of records, comparing the operation data with each of a second plurality of records, wherein each of the second plurality of records comprises information indicative of a routine operation to be performed within the process tool; and
providing an alarm signal to the process tool if the operation data does not match any one of the second plurality of records.

21. The method as recited in claim 20, wherein the special operation information is used in manual execution in the process tool, and wherein the routine operation information is used in auto-execution in the process tool.

22. The method as recited in claim 20, wherein:
the receiving comprises receiving operation data from the process through a cell controller; and
the providing comprises providing the alarm signal to the process tool through the cell controller.

23. The method as recited in claim 20, and further comprising providing the alarm signal to a user interface to alert a user if the operation data does not match any one of the second pluralities of records.
